(19) United States
(12) Patent Application Publication
(10) Pub. No.: US 2004/0204207 A1
(43) Pub. Date: Oct. 14, 2004

(54) Hat for hands-free telephone operation

(76) Inventor: John A. Parker, Plano, TX (US)

Correspondence Address: LITMAN LAW OFFICES, LTD., P.O. BOX 15035 CRYSTAL CITY STATION, ARLINGTON, VA, 22215, US

(21) Appl. No.: 10/138,574

(22) Filed: May 6, 2002

(51) Int. Cl. H04M 1/00

(52) U.S. Cl. 455/575.2; 455/569.1

(57) ABSTRACT

A hat, or baseball cap, modified to include a removable headset having a speaker and microphone and a rear mounted pocket holding a cell phone, the hat having an internal flap. held in place by VELCRO, and slits for running cord between the headset and the cell phone. The headset is snapped to the hat to overhang the wearer's ear. A speaker is located near the ear, and a swiveling microphone arm is provided. A button on the microphone allows the wearer to answer calls, hang up, or activate phone voice recognition to make telephone calls. The headset and cell phone may be easily removed for cleaning by pulling away the cord holding flap, disconnecting it from the phone, removing the phone from the pocket and unsnapping the headset from the hat. The phone and headset system can be reinstalled on a similar hat.

### BACKGROUND OF THE INVENTION

1. Field of the Invention

The present invention relates to body supported telephone devices. More particularly, the present invention relates to a hat for a supporting cellular telephone and connected headset microphone and earpiece.

2. Description of the Related Art

The use of cellular telephones(cell phone) is increasingly widespread. One disadvantage is that they require the use of at least one hand to carry and another to dial. Although voice-activated dialing is now available, the use of a standard cell phone is still awkward, particularly for those persons carrying out duties such as coaching or watching or taking part in sports and exercise endeavors or doing manual labor. It would be desirable to provide a cell phone which may be carried on the body and is connected to a headset worn by the user which requires minimal use of the hands, to leave them free to carry items such as notebooks and allow writing on notebooks during the use of the cell phone. It would be even more useful if the cell phone, headset, and all associated equipment was located in a single hat worn by the user. Although radio operated, communication gear is known which is mounted in a helmet or other head cover, this technology is inadequate for those persons who want to make and receive private communications by telephone from a public telephone system. It would also be useful if the hat provided is a sports cap in team colors. It would be further useful if the telephone equipment is removable from the cap for transfer to a second cap having other team colors while leaving the first cap for separate use. It would also be useful if the telephone equipment is removable from the cap to allow the cap to be cleaned without damaging the telephone equipment.

W.I.P.O., Patent No. WO 95/18490, published Jul. 6, 1995 describes a communications device that is wearable as a hat and is designed to function as a cellular telephone. In one embodiment cell phone circuitry is included within the hat and may be voice actuated. A control unit having a key pad is located on the wearer's wrist. A flexible circuit board and microphone wiring is held in the headband.

U.S. Pat. No. Des. 333,375, issued Feb. 23, 1993, to Oueliette, illustrates a combined hat and back-mounted pocket.

U.S. Pat. No. 5,634,201, issued May 27, 1997, to Mooring, describes a specialized visor which provides for a number of functions including cell phone use. The cell phone is separately carried in a shoulder holster.

U.S. Pat. No. 5,685,017, issued Nov. 11, 1997, to Kraft describes a modular hat having a headband and capable of holding a variety of items, including phones, earphones, and microphones. One embodiment illustrates a VELCRO-covered headband inner side, apparently for attaching items such a neck shade.

U.S. Pat. No. 5,689,558, issued Nov. 18, 1997, to Osgood et al., describes a headgear mounting for a handset such as a cell phone. The mounting is removably mounted by the use of snap fasteners.

Japanese Patent No. JP2-226852, published Sep. 10, 1990, describes a headset shaped like a cap.

None of the above inventions and patents, taken either singularly or in combination, is seen to describe the instant invention as claimed. Thus, a hat for hands-free telephone operation solving the aforementioned problems is desired.

### SUMMARY OF THE INVENTION

The present invention is a hat, preferably a baseball style cap, modified to include a removable headset having a speaker and microphone and a rear mounted pouch or pocket for receiving a cell phone, the hat providing an internal flap and slits for running a cord between the headset and the cell phone.

A headset body is removably mounted by snaps to the side of the hat so as to overhang the wearer's ear. A speaker opens on the inner side of the body near the wearer's ear, and a microphone arm is attached for swiveling motion on the outer side of the body. A standard type voice activated cell phone fits into the pouch or pocket, and a cord running from the headset body has a connector for connection with the headphone jack on the phone. A VELCRO-held inner flap provides for removably securing the cord between the headset and a slit in the side of the cap which allows the cord to emerge from the hat therethrough and enter the bottom or lower side of the pocket or pouch for connection with the phone. Connector adapters are made available to fit most popular cell phones on the market. A button on the microphone is pressed by the wearer, allowing him to answer phone calls when the phone rings or activate the phone voice recognition system to make telephone calls, or hang up the phone when the call is completed, thus reducing the need for hand use to an absolute minimum.

Similar hats are available having different colors such as sports team colors. The headset, cord, and telephone are transferable between hats for use at different sports events. The hats are also useful for wear without the telephone and headset system and the pouch or pocket used to carry personal articles.

The inventive phone hat is useful while carrying on a variety of endeavors such as driving, sports, exercise, sports coaching, and work. The phone may optionally be integrated with MP3 players to play music heard over the headset speaker when the phone is not in use. Hats can be customized with colors, stickers, logos, or other indicia related to a sports team or organization, and novelty items such as simulated antenna, to appeal to a variety of users.

The inventive hat is designed for maximum hands-free operation and is capable of being answered and dialed with minimal use of the hands. No buttons need be pushed on the phone, itself, once turned on and connected within the telephone hat. The single button on the microphone answers the phone if ringing, hangs up the phone, and initiates the voice activated dialing system of the telephone when the phone is not ringing. Many cell phones and telephone companies currently on the market offer voice dialing capability. Most of the telephones have a connector jack for use with headsets for limited hands free operation. There are some headset manufacturers, such as Plantronics, Santa Cruz, Calif., that sell headsets with button the answer, hang up, and activate the phone's voice dialing function. It is not known by the present inventor of anyone who has incorporated this function with a phone into a cap or hat. but most of these services require that buttons on the phone be pushed to activate the voice dialing function.

To initiate the voice activated dialing system from the microphone-mounted button on the telephone hat, the phones must be slightly modified to provide circuitry to allow remote control for this function via the headphone connector jack on the particular phone. Widespread use of the inventive hat will induce cellular telephone makers to provide this feature.

Accordingly, it is a principal object of the invention to provide a hat providing hands-free cell phone capability.

It is another object of the invention to provide a hat as above having a rear mounted pocket for carrying a standard configuration cell phone.

It is a further object of the invention to provide a hat as above having a mounting for removably mounting a headset in the vicinity of a wearer's ear.

Still another object of the invention is to provide a hat as above having a VELCRO flap in the shape of a partial head band which removably stores connector wiring between the headset and the cell phone within the rear mounted pocket.

It is yet another object of the invention to provide a hat as above where all communications equipment may be removed from the first hat and moved to a second hat, the first hat remaining wearable as a hat and the pocket useable to carry personal articles as desired.

It is still another object of the invention to provide a hat as above where the communication equipment may be moved from a first hat having one set of sports team colors and logos to another similar hat having another sports team colors and logos.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a hat for hands-free telephone operation according to the present invention.

FIG. 2 is a rear perspective view of the telephone hat of FIG. 1.

FIG. 3 is a side elevation view of the telephone hat of FIG. 1 having the cord-retaining VELCRO flap open.

FIG. 4 is an exploded view of the telephone hat of FIG. 1.

FIG. 5 is an end elevation view of the ear piece/microphone assembly of FIG. 4.

FIG. 6 is a side elevation view of the inner side of the ear piece/microphone assembly of FIG. 4.

FIG. 7 is a side elevation view from the reverse side of FIG. 3, illustrating the hook and loop material patches in the open position.

Similar reference characters denote corresponding features consistently throughout the attached drawings.

### DETAILED DESCRIPTION OF THE PREFERRED EMBODIMENT

The present invention is a hat, preferably a baseball style cap, modified to include a removable headset having a speaker and microphone and a rear mounted pouch or pocket for receiving a cell phone, the hat providing an internal flap and slits for running a cord between the headset and the cell phone. A pushbutton is located on the microphone or headset body for the wearer to answer a ringing telephone, hang up calls, or to initiate voice-activated dialing.

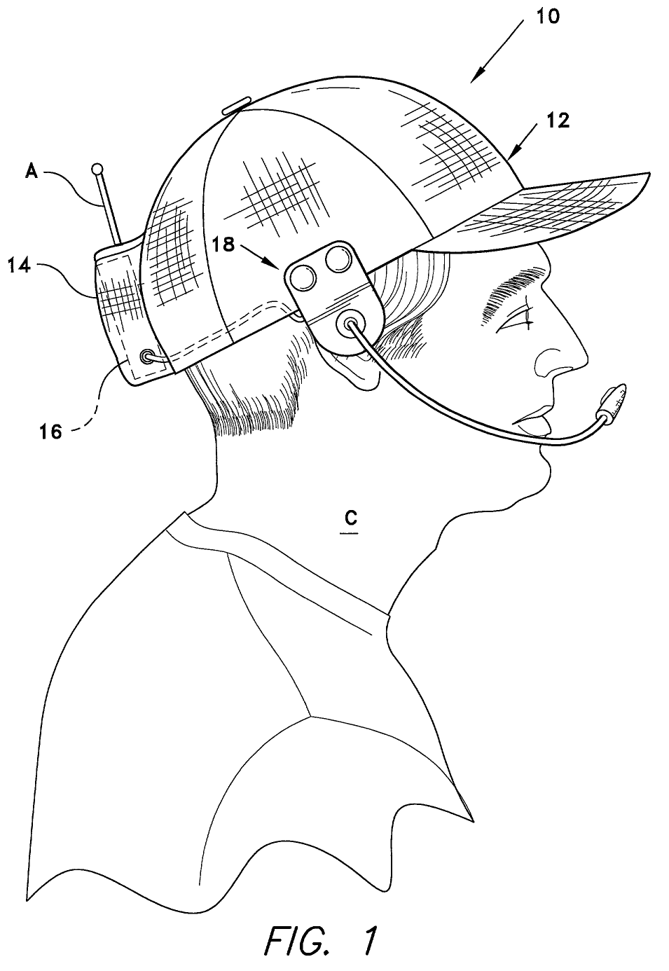

Referring to FIG. 1, there is shown an environmental perspective view of the phone hat system 10 as worn by a user C. The phone hat system 10 includes a baseball style hat 12 having a rear mounted pocket or pouch 14. A cell phone 16 is located in pocket 14 with antenna A of cell phone 16 extending upward out of pocket 14. A headset 18 is removably attached to the side of hat 12 near the user's ear and includes a cord reaching to pocket 14 for connection with cell phone 16.

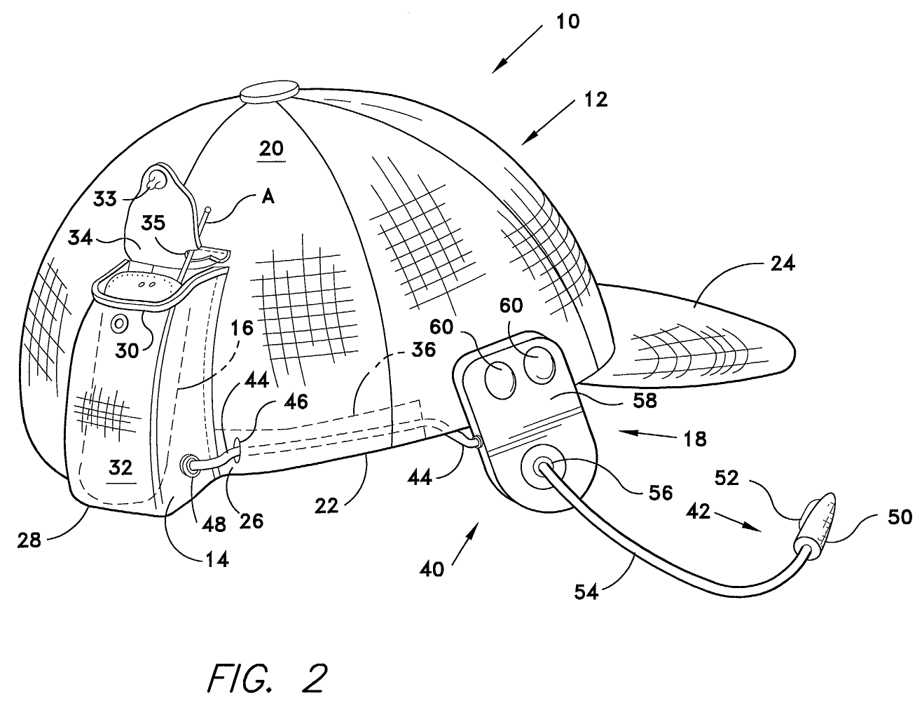

Referring to FIG. 2, hat 12 has a crown 20, a lower brim 22, a bill 24 and a rear portion 26 opposite bill 24. Phone pocket 14 is attached to hat 12 at rear portion 26 along lower brim 22 and includes a bottom wall 28, an upper opening 30 formed by pocket sidewall 32. Upper opening 30 is covered by flap 34 and is removably fastened to sidewall 32 by a snap 33 to provide access to cell phone 16. Flap 34 has an opening 35 to allow extension of antenna A when flap 34 is closed over cell phone 16. Inner band 36, attached to lower brim 22 in the manner of a partial hat band is removably held to the inner wall of hat 12 by hook and loop material such as VELCRO. Ear piece assembly 40 includes a mouth piece 42, and a rear telephone connector cable 44 running between securing flap 36 and the inner side of hat 12, exiting through cable exit slot 46, and entering phone pocket 14 through cable entrance 48 located in the lower end of sidewall 32 (as shown) or in the pocket bottom 28.

Headset 18 includes mouth piece 42 having a microphone 50 and an actuator button 52. Mouth piece 42 is attached to microphone cable holder arm 54, which is rotatably attached by rotatable microphone mount 56 to ear piece body 58. Actuator button 52 may alternatively be placed on ear piece body 58 as desired. Ear piece body 58 is removably attached by snaps 60 at a location along the side of hat 12 so as to overhang hat brim 22 in the location of the wearer's ear.

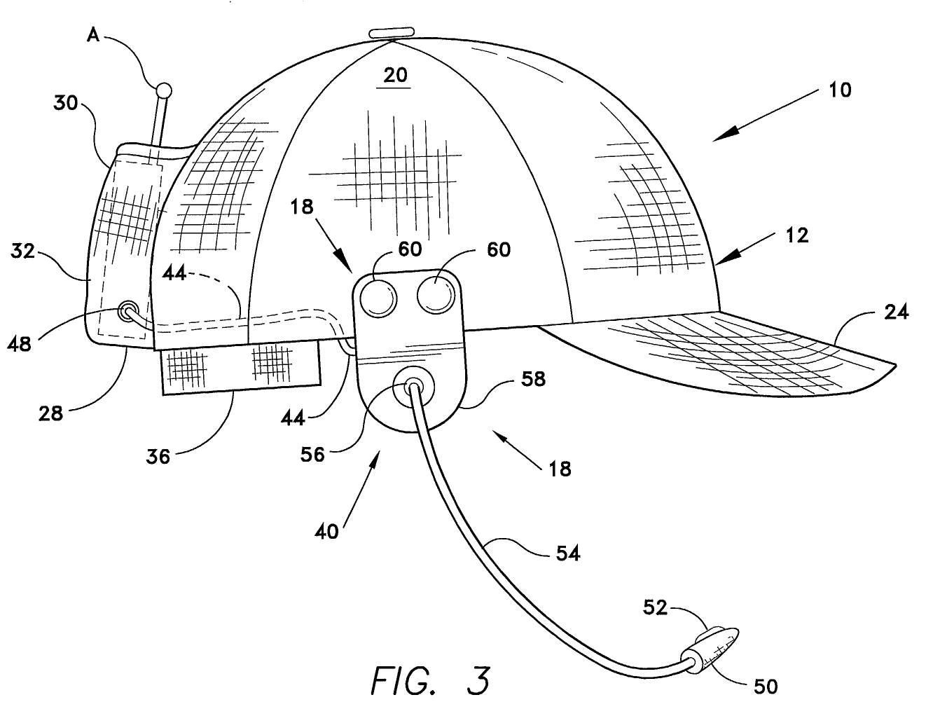

Referring to FIG. 3, there is shown a side view in elevation of the phone hat system 10 where securing flap 36 has been removed from adhesion to the inner side of hat 12 and hangs downward, depending from hat brim 22 to expose connector cable 44 for removal of the headset 18 and cell phone 16 from hat 12. The securing flap 36 also provides comfort to the user by protecting him from direct contact with the connector cable 44.

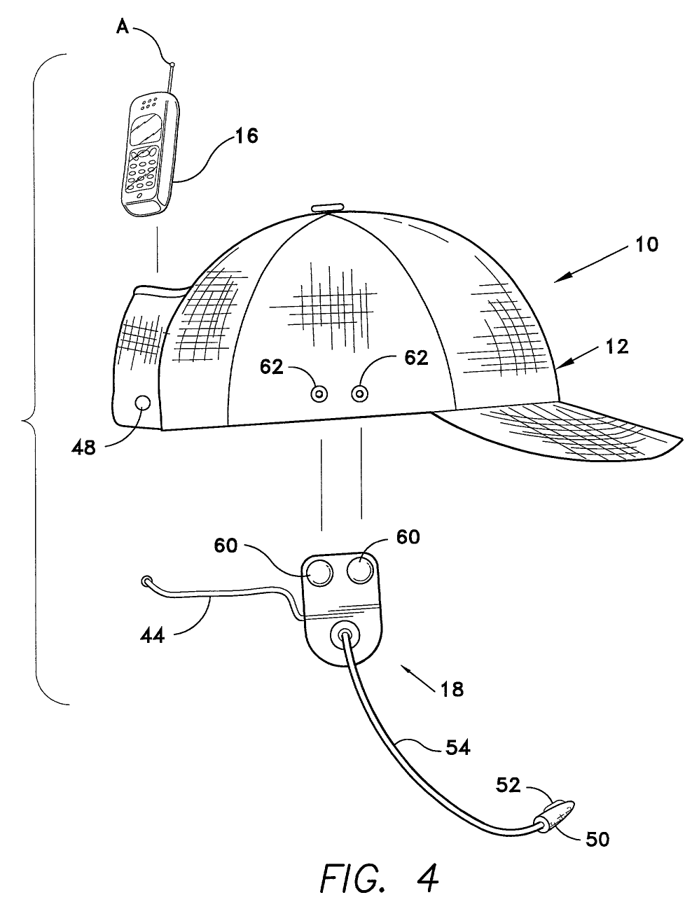

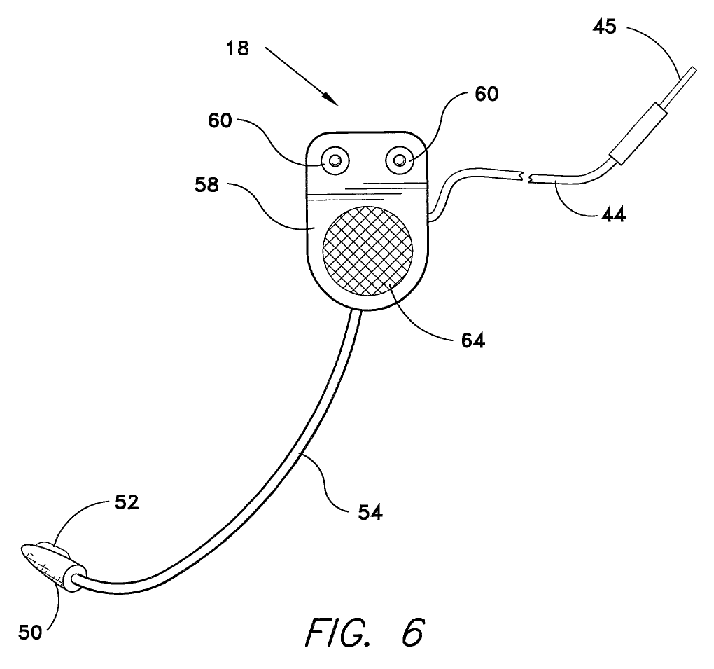

Referring to FIG. 4, there is shown an exploded side view with phone 16 and headset 18 separated from hat 10 exposing hat snap sockets 62 attached permanently to the side of hat 12 for receiving the snap studs(see FIG. 6) of snaps 60. It may be seen that the headset may be removed from hat 12 by disconnecting cable 44 from a connector(not shown) on phone 16, releasing snaps 60, and releasing securing flap 36(see FIG. 3). The phone 16 may then be removed by opening pocket flap 34. Alternatively, the flap 34 may be deleted from pocket 14 leaving it as an open pocket as shown.

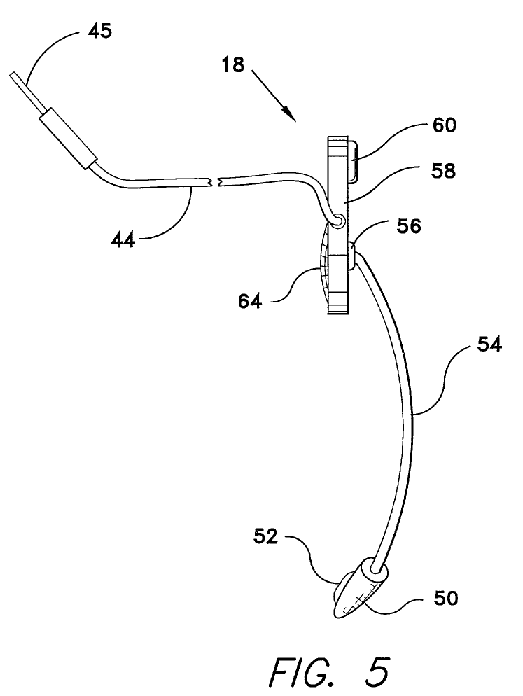

Referring to FIGS. 5 and 6, there are shown an end elevation view and an inner side elevation view, respectively, of the headset 18. Ear piece body 58 includes speaker 64 on its inner side and is connected to hat 60 by snapping the studs of snaps 60 into snap sockets 62 (see FIG. 4). Cable connector 44 is shown having telephone connector 45 for connecting with the earphone jack(not shown) of the cell phone.

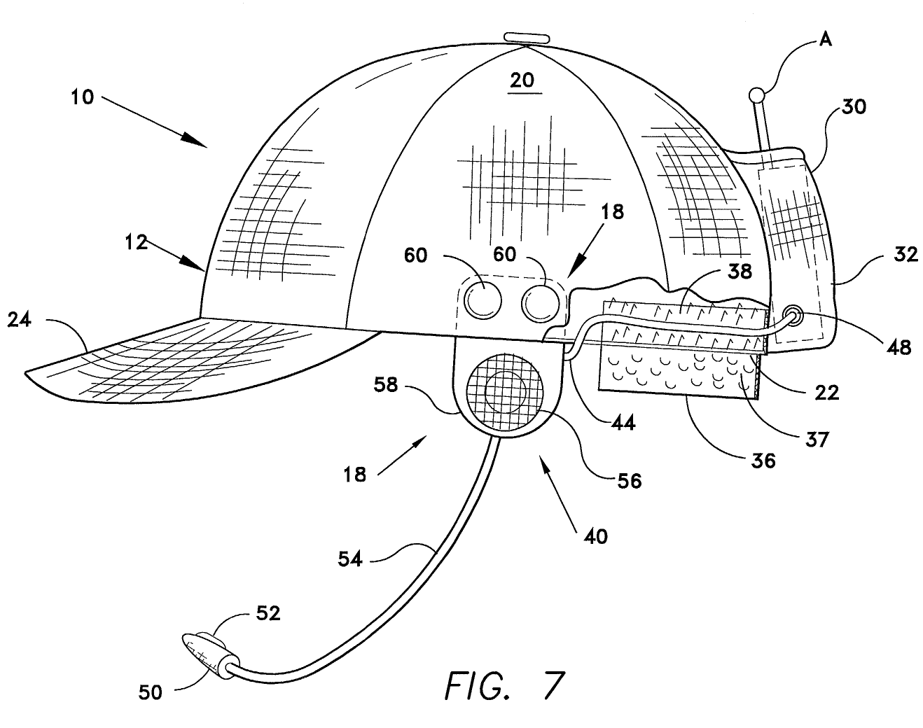

Referring to FIG. 7, there is shown a reverse view similar to that of FIG. 3, illustrating the inner side of flap 36 in the open position, flap 36 having a loop material patch on its inner face, and further illustrating a corresponding patch of hook material 38 mounted on the inner side of hat 12. As can be seen, connecting cable 44 is free to be removed when flap 36 is in the open, downward position.

The telephone hat may be supplied in a variety of sizes and made from any suitable materials. The material may be wool for winter use, and cotton, synthetic material, or polymer mesh material for summer use. The hat may be of any desired combination of colors, such the colors of a sports team or other organization.

It is to be understood that the present invention is not limited to the embodiments described above, but encompasses any and all embodiments within the scope of the following claims.

I claim:

1. A telephone hat having hands-free telephone operation comprising:
a hat having a pocket mounted thereon, so sized and configured as to receive a cellular telephone;
a headset mounted a side of said hat;
said headset having a connector cable extending rearward to the base portion of said pocket; and
said cable having a connector for connection with the headphone socket of a cellular telephone;
whereby the user may answer a ringing cellular telephone located within said pocket, hang up the telephone, and actuate the voice-actuated feature of the telephone.

2. The telephone hat of claim 1, said pocket being rear-mounted and upward-opening, said hat having a lower surrounding brim.

3. The telephone hat of claim 2, wherein said headset further comprises:
an earpiece body removably mounted on the side of said hat so as to overhang the user's ear below said brim;
a speaker mounted on a lower portion of an inner side of said earpiece body and positioned below said brim;
an actuator button for answering said cellular telephone when ringing and for actuating voice actuated dialing of said telephone;
a microphone;
a microphone arm holding said microphone at a remote end in the vicinity of the users' mouth and rotatably attached to said earpiece body on an outer side thereof and connecting said microphone and said earpiece body for transfer of signals therebetween;
whereby said microphone may alternately be moved to the user's mouth for conversation purposes or moved away from the users mouth to a storage position by rotating said microphone arm around said earpiece body.

4. The telephone hat of claim 3, wherein said actuating button is located on said microphone.

5. The telephone hat of claim 3, wherein said hat actuating button is located on said ear piece body.

6. The telephone hat of claim 3, wherein said ear piece body has at least one snap socket located on an upper portion of said inner side of said ear piece, and said hat has at least one snap stud on a side thereof above the user's ear for removable attachment of said ear piece body of said headset, whereby said speaker is positioned over the ear of the user.

7. The telephone hat of claim 6, wherein there are two snap sockets located on said ear piece and two corresponding snap studs located on said hat for receiving said snap sockets.

8. The telephone hat of claim 3, wherein said hat has a lower brim and partial band extending upward from said brim on the inside of said hat and extending around said brim between said ear piece body and said rear mounted pocket, said connector cable being positioned between said partial band and the inside surface of said hat along said brim thereof.

9. The telephone hat of claim 8, wherein said partial band is removably attached to the inside surface of said hat by hook and loop material, whereby said partial band may be pulled away from the inside of said hat for removal of said connector cable while remaining attached at said brim.

10. The telephone hat of claim 8, wherein said hat has a slit near said lower brim at the pocket end of said partial band and near said pocket and so sized as to allow the exit of said connector cable therethrough to the outside of said hat.

11. The telephone hat of claim 10, said pocket having a bottom wall and a surrounding side wall, said pocket having an entrance in one of said bottom wall and the lower portion of said side wall for receiving said connector cable for connection with the cellular telephone held within said pocket.

12. The telephone hat of claim 2, wherein said pocket has a cover flap, said cover flap defining an opening for extension of the antenna of the cellular telephone contained within said pocket.

13. The telephone hat of claim 2, wherein said headset and said telephone are removable from said hat and are transferable to another similar hat, thereby allowing said hat to be cleaned without damaging the said had set and said telephone.

14. The telephone hat of claim 12, wherein said hat has identifying colors, logos, and decorations identifiable with certain sports teams and said headset and telephone is transferable to said similar hat with different colors, logos, or decorations identifiable with another sports team.

15. The telephone hat of claim 13, wherein said hat has novelty items mounted thereon.

16. The telephone hat of claim 3, wherein said hat is a baseball style cap having a front located bill which is useful for wear absent said cellular telephone and headset and said pocket is useful for carrying personal articles.

17. A telephone hat having hands-free telephone operation comprising:
a baseball style hat having a front mounted bill, a crown portion, and a surrounding lower brim defining the lower edge of said crown, said hat having an rear-mounted upward-opening pocket so sized and configured as to receive a cellular telephone;
a headset mounted a side of said hat;
said headset having a connector cable extending rearward to the base portion of said pocket; and
said cable having a connector for connection with the headphone socket of a cellular telephone;
said headset further comprising:
an earpiece body removably mounted on the side of said hat so as to overhang the user's ear below said brim;
a speaker mounted said brim on a lower portion of an inner side of said earpiece body and located below said brim;
an actuator button for answering said cellular telephone when ringing, for hanging up said cellular telephone, and for actuating voice actuated dialing of said telephone;
a microphone;
a microphone arm holding said microphone at a remote end in the vicinity of the users's mouth and rotatably attached to said earpiece body on an outer side thereof and connecting said microphone and said earpiece body for transfer of signals therebetween;
whereby the user may answer a ringing cellular telephone located within said pocket, hang up the telephone, and actuate the voice actuated feature of the telephone; and
whereby said microphone may alternately be moved to the user's mouth for conversation purposes or moved away from the users mouth to a storage position by rotating said microphone arm around said earpiece body.

18. The telephone hat of claim 17, wherein said actuating button is located on said microphone.

19. The telephone hat of claim 17, wherein said actuating button is located on said ear piece body.

20. The telephone hat of claim 17, wherein said headset and said telephone are removable from said hat and are transferable to another similar hat, and wherein said hat has identifying colors, logos, and decorations identifiable with certain sports teams and said headset and telephone is transferable to said similar hat with different colors, logos, or decorations of another sports team.
